(19) United States
(12) Patent Application Publication
(10) Pub. No.: US 2021/0216342 A1
(43) Pub. Date: Jul. 15, 2021

(54) SYSTEM, SERVER, VERIFICATION METHOD AND PROGRAM

(71) Applicant: NEC Corporation, Tokyo (JP)

(72) Inventors: Ryosuke OHARA, Toyko (JP); Yujin YOKOGAWA, Tokyo (JP)

(73) Assignee: NEC Corporation, Tokyo (JP)

(21) Appl. No.: 15/734,038

(22) PCT Filed: Jun. 4, 2019
(86) PCT No.: PCT/JP2019/022137

§ 371 Date: Dec. 1, 2020

(30) Foreign Application Priority Data
Jun. 5, 2018 (JP) 2018-107970

(51) Int. Cl. G06F 9/455; G06Q 50/18

(52) U.S. Cl. CPC G06F 9/45558; G06F 2009/45562; G06Q 50/184

(57) ABSTRACT

A system comprises an execution server, a control server and an IP storage. The execution server is equipped with an FPGA and creates a virtual machine which uses the FPGA as one of hardware resources. The control server controls the execution server. The IP storage stores an IP to be downloaded to the FPGA. The control server makes reference to a check sheet including information for associating at least an identifier of the virtual machine with an API used by the virtual machine and verifies the pertinency of a combination of the virtual machine and the IP which has been stored in the IP storage and to be downloaded to the FPGA.

### CROSS-REFERENCE TO RELATED APPLICATION

The present invention is based on priority of JP Patent Application No. 2018-107970 (filed on Jun. 5, 2018). The entire contents thereof are incorporated by reference into the present application.

### FIELD

The present invention relates to a system, a server, a verification method and a program.

### BACKGROUND

Recently, along with development of technologies, such as big data and IoT (Internet of Things), systems requiring processing of large volume data are increased. Because of such situation, the systems are requested to perform at a further higher speed.

As one solution for systems performing at higher speed, HW (Hardware) accelerator is used, that realizes a part of software processing by a hardware implement. There is an FPGA (Field Programmable Gate Array) as a device suitable for HW accelerator technology.

The FPGA has the following features as disclosed in Non-Patent Literature 1. The FPGA may be rewritten for a process (application) after chip production. In addition, since the process may be rewritten, it is possible by using the FPGA to realize market introduction (trial) at a small start where initial cost is suppressed. Further, the FPGA also has advantages that resources (such as CPU (Central Processing Unit) resource, power consumption and like) are reduced and processing may be performed at a higher speed.

Further, MCP (Multi Chip Package) type FPGA where the FPGA and a CPU are tightly connected has been stated to provide, thus it is assumed that the FPGA would be further used in the feature.

In addition, on the other hand, along with improvement in NFV (Network Function Virtualization) technology, system construction on a virtualized infrastructure starts to prevail, thus it is prospected that opportunity for using the FPGA and NFV technology in combination would be increased.

### CITATION LIST

### Non-Patent Literature

Non-Patent Literature 1: Intel, “Resource center with which basic configuration of FPGA may be understood”, [online], [searched on May 24, 2018], internet <URL:https://www.altera.co.jp/products/fpga/new-to-fpgas/resource-center/overview.html?utm_source=Altera&utm_medium=link&utm_campaign=Homepage&utm_content=Staircase>

### SUMMARY

### Technical Problem

The disclosure of the above literature of Citation List is to be incorporated herein by reference. The following analyses have been made by the present inventors.

As described above, it is supposed that a system in which an FPGA and a virtualized infrastructure (NFV technology) are combined would prevail in the feature. In the system where the FPGA and the NFV technology are combined to be used, from an aspect of an eco-system where a variety of main subjects are cooperated to create a system, it is supposed that a variety of managers are different, respectively.

For example, it is supposed that a developer/manager who develops a service (application/workload), a developer/manager of an IP (Intellectual Property; an FPGA circuit) and a constructor/manager of infrastructure (IaaS; Infrastructure as a Service) are different from one another. Herein, in the explanation below, the developer/manager for a service is referred to as a “service manager”, the developer/manager for an IP is referred to as an “IP manager”, and the constructor/manager for an infrastructure is referred to as an “infrastructure manager” respectively. In addition, the managers are referred to as a comprehensive name “stakeholder(s)”.

Usually, operations required for setting up the system and managing it are in charge of different operators, respectively, and each person operates independently. Therefore, intervention to the mutual operations is difficult, resulting in a possibility that the following problems occur. Since the service manager is different from the IP manager and a virtual machine and an IP have a different life cycle from one another, development of an application and release of the IP (IP core) occur at different timings. Therefore, it may occur that the IP is not implemented with an API (Application Programming Interface) which is expected by a virtual machine (VM; Virtual Machine). That is, there is a possibility that the virtual machine and the IP might be used in an unsuitable combination.

It is a main purpose of the present invention to provide a system, server, verification method and program, that contribute to prevent that a virtual machine and an IP written in an FPGA utilized by the virtual machine are set in an unsuitable combination.

### Solution to Problem

According to a first aspect of the present invention, there is provided a system, comprising:

an execution server that is equipped with an FPGA (Field Programmable Gate Array) and creates a virtual machine which uses the FPGA as one of hardware resources,
a control server that controls the execution server, and
an IP storage that stores an IP (Intellectual Property) to be downloaded to the FPGA,
wherein the control server makes reference to a check sheet including information for associating at least the virtual machine with an API (Application Programming Interface) used by the virtual machine and verifies the pertinency of a combination of the virtual machine and the IP which has been stored in the IP storage and to be downloaded to the FPGA.

According to a second aspect of the present invention, there is provided a control server, connected to

an execution server that is equipped with an FPGA (Field Programmable Gate Array) and creates a virtual machine which uses the FPGA as one of hardware resources, and
an IP storage that stores an IP (Intellectual Property) to be downloaded to the FPGA, and
making reference to a check sheet including information for associating at least the virtual machine with an API (Application Programming Interface) used by the virtual machine and verifies the pertinency of a combination of the virtual machine and the IP which has been stored in the IP storage and to be downloaded to the FPGA.

According to a third aspect of the present invention, there is provided a verification method in a system comprising:

an execution server that is equipped with an FPGA (Field Programmable Gate Array) and creates a virtual machine which uses the FPGA as one of hardware resources,
a control server that controls the execution server, and
an IP storage that stores an IP (Intellectual Property) to be downloaded to the FPGA, wherein the method includes:
a step of making reference to a check sheet including information for associating at least the virtual machine with an API (Application Programming Interface) used by the virtual machine, and
a step of verifying the pertinency of a combination of the virtual machine and the IP which has been stored in the IP storage and to be downloaded to the FPGA.

According to a fourth aspect of the present invention, there is provided a program, causing a computer installed in a control server connected to an execution server that is equipped with an FPGA (Field Programmable Gate Array) and generates a virtual machine which uses the FPGA as one of hardware resources, and to an IP storage that stores an IP (Intellectual Property) to be downloaded to the FPGA,

to execute a process of making reference to a check sheet including information for associating at least the virtual machine with an API (Application Programming Interface) used by the virtual machine, and
to execute a process of verifying the pertinency of a combination of the virtual machine and the IP which has been stored in the IP storage and to be downloaded to the FPGA.

Herein, the program may be stored in a computer readable storage medium. The storage medium may be a non-transient one, such as a semiconductor memory, hard disk, magnetic recording medium, optical recording medium and like. The present invention may be realized as a computer program product.

### Advantageous Effects of the Invention

According to each of aspects of the present invention, there are provided a system, a server, a verification method and a program, which contribute to prevent that a virtual machine and an IP written in an FPGA utilized by the virtual machine are set in an unsuitable combination.

### BRIEF DESCRIPTION OF THE DRAWINGS

FIG. 1 is an explanatory view of an outline of one exemplary embodiment.

FIG. 2 is a diagram showing an outline configuration of a cloud system of a first exemplary embodiment.

FIG. 3 is an explanatory view of an operation on a cloud system of the first exemplary embodiment.

FIG. 4 is an explanatory view of an operation on the cloud system of the first exemplary embodiment.

FIG. 5 is a diagram showing an example of a processing configuration of a control server of the first exemplary embodiment.

FIG. 6 is a diagram showing an example of a processing configuration of an execution server of the first exemplary embodiment.

FIG. 7 is a diagram showing an example of a hardware configuration of the control server of the first exemplary embodiment.

FIG. 8 is a diagram showing an example of a hardware configuration of the execution server of the first exemplary embodiment.

FIG. 9 is a flowchart showing an example of previous preparation before system operation in the first exemplary embodiment.

FIG. 10 is a flowchart showing an example of operations by the control server and the execution server of the first exemplary embodiment.

### MODES

First of all, an outline of one exemplary embodiment is explained. Herein, reference signs in this outline are expediently attached to each element as an explanatory aid for understanding, thus any limitation is not intended by this outline. In addition, connection lines between blocks in each figure include both of bidirectional connection and one directional connection. One way arrow schematically indicates flow of main signal (data), but not excluding bidirection. Further, although being omitted in a circuit diagram, block diagram, inner configuration diagram, connection diagram and like of the present disclosure, an input port and an output port are present, respectively, on an input end and an output end of each connection line. The same is applied to input/output interfaces.

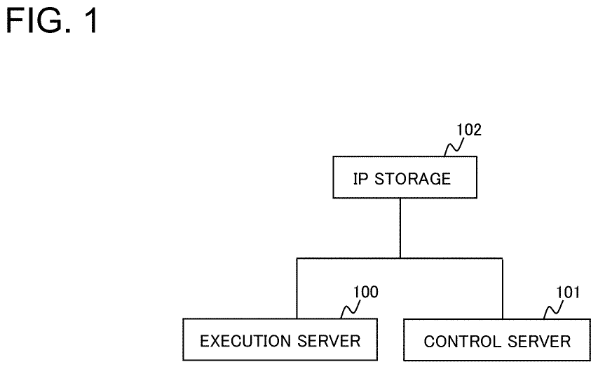

A system of one exemplary embodiment comprises an execution server 100, a control server 101, and an IP storage 102 (see FIG. 1). The execution server 100 is equipped with FPGA and creates a virtual machine which uses FPGA as one of hardware resources. The control server 101 controls the execution server 100. The IP storage 102 stores IP to be downloaded to FPGA. The control server 101 makes reference to a check sheet including information for associating at least an identifier of the virtual machine with API used by the virtual machine and verifies the pertinency of a combination of the virtual machine and IP which has been stored in the IP storage and to be downloaded to the FPGA.

In the system, a service manager creates the check sheet independently. The check sheet includes at least a virtual machine name created by the service manager and API information requested by the virtual machine. The control server 101 makes reference to the check sheet and verifies the pertinency of a combination of virtual machine and IP using API information requested by the virtual machine and API information provided by IP which has been registered on the IP storage 102 by the IP manager upon IP release. By virtue of the verification, occurring of a situation may be prevented where even though a virtual machine has been created in the execution server 100, API to be used by the virtual machine has not been registered on the IP storage 102, resulting in that the virtual machine and IP are used in an unsuitable combination. Accordingly, in the above system, the pertinency in the combination of the virtual machine and IP may be verified while keeping relatively prime relationship between stakeholders (for example, service manager, IP manager).

Concrete exemplary embodiments will be explained in further detail while referring to drawings. Herein, the same reference numerals are affixed to the same component in each exemplary embodiment, thus explanation thereof is omitted.

### FIRST EXEMPLARY EMBODIMENT

A first exemplary embodiment will be explained in further detail using drawings.

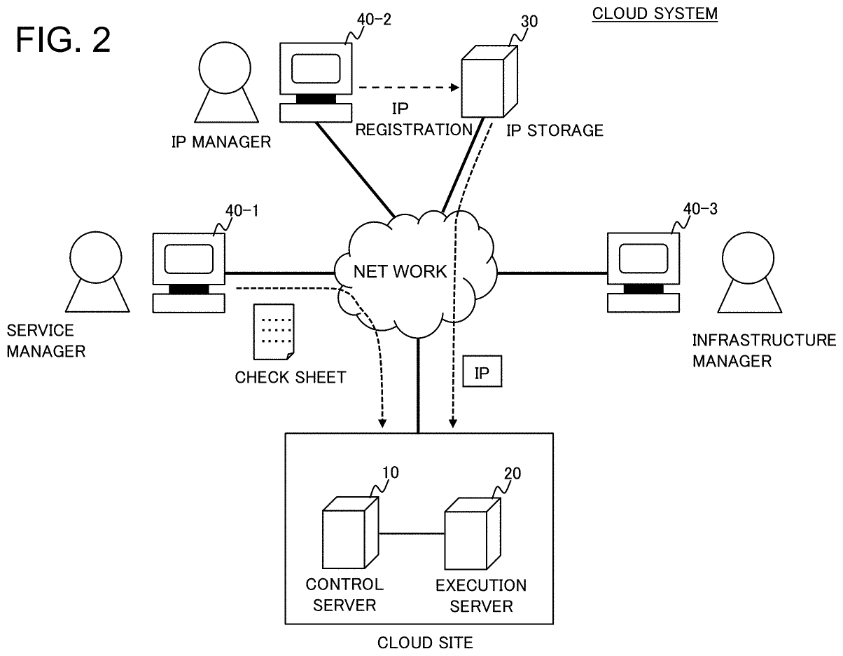

FIG. 2 is a diagram showing an outline configuration of a cloud system of the first exemplary embodiment. As illustrated in FIG. 2, the cloud system is configured to comprise a control server 10 and an execution server 20 established on a cloud site, and an IP storage 30 and terminals 40-1 to 40-3.

In the cloud system illustrated in FIG. 2, a virtual machine is created in the execution server 20 and a service and an application are provided to a user using a virtual machine(s). For example, the cloud system realizes big data analysis and information processing by AI (Artificial Intelligence). Herein, a user who utilizes the cloud system and a terminal utilized by the user are not illustrated in FIG. 2.

The control server 10 is an apparatus that controls the cloud site. Particularly, the control server 10 controls the execution server 20. For example, the control server 10 creates a virtual machine on the execution server 20.

The execution server 20 is, for example, an apparatus (physical machine) for providing cloud computing. The execution server 20 is equipped with an FPGA. A virtual machine that uses FPGA as one of hardware resources is created on the execution server 20. That is, the execution server 20 creates a virtual machine (VM) within itself and uses the virtual machine to provide application, service, etc., to a user.

The IP storage 30 is an apparatus (server) that stores IP developed by an IP manager (for example, user, FPGA vendor, partner company). The IP storage 30 is a server (server for providing a web site) and like that stores IP to be downloaded to FPGA on the execution server 20. The IP developer converts a circuit developed by himself to an IP core, and registers (releases) the IP core on the IP storage 30. At that time, the IP developer also registers API information provided by IP and an IP check sum on the IP storage 30.

The terminal 40-1 is a terminal used by a service manager. The service manager creates a check sheet for a virtual machine that provides an application (service) using the terminal 40-1 and transmits the check sheet to the cloud site (infrastructure).

The check sheet includes information for identifying a virtual machine that provides an application on the cloud system (identifier), API information used by the virtual machine (information for identifying API; identifier) and a test pattern for verification of communication between the virtual machine and IP.

The terminal 40-2 is a terminal utilized by an IP manager. The IP manager develops a circuit required for FPGA assigned to the virtual machine described on the check sheet as IP. For example, in a case where the virtual machine is used for big data analysis, IP manager develops IP that realizes HW (hardware) accelerator for the big data analysis.

In addition, the IP manager installs to the IP a function for executing the test pattern described on the check sheet. Concretely, the IP manager installs to the IP a “communication verification part” that, when a test pattern described on the check sheet is provided to FPGA to which IP has been written, executes the test pattern.

The IP manager registers the developed IP on the IP storage 30 using the terminal 40-2. At that time, the IP manager creates a check sum for the developed IP (IP provided to the IP storage 30) and registers the check sum while associating with the developed IP and API thereof on IP storage 30. A calculation of the check sum may be realized by any methods. For example, the check sum may be calculated by a method similar to a check sum stored in a TCP (Transmission Control Protocol) header.

Herein, the IP storage 30 creates API list information (supply API list) and IP check sum list information (check sum list) provided by each IP stored in the IP storage 30 based on information registered by the IP manager. The IP storage 30 provides the control server 10 and the execution server 20 with these list information as necessary.

The terminal 40-3 is a terminal utilized by an infrastructure manager. The infrastructure manager executes construction and management of the cloud site (infrastructure) using the terminal 40-3.

In FIG. 2, the control server 10 makes reference to the check sheet including information for associating a virtual machine and API used by the virtual machine and verifies the pertinency of a combination of the virtual machine and the IP that has been stored in the IP storage and is to be downloaded to the FPGA. That is, it is verified whether or not there is a problem in the combination of virtual machine and the IP (circuit), pertinency of the virtual machine constructed on the execution server 20 with the IP (circuit) is confirmed.

After that, with respect to the IP that is determined as having a pertinent combination, required IP is downloaded from the IP storage 30 and written to FPGA installed on the execution server 20.

At that time, identity is verified between IP downloaded to FPGA and an IP that corresponds to downloaded IP to FPGA and is stored in the IP storage. Further, operations on the virtual machine (application) and the IP (circuit) are actually verified. That is, it is verified whether the virtual machine and the IP (circuit) operate on the execution server 20 in a normal fashion.

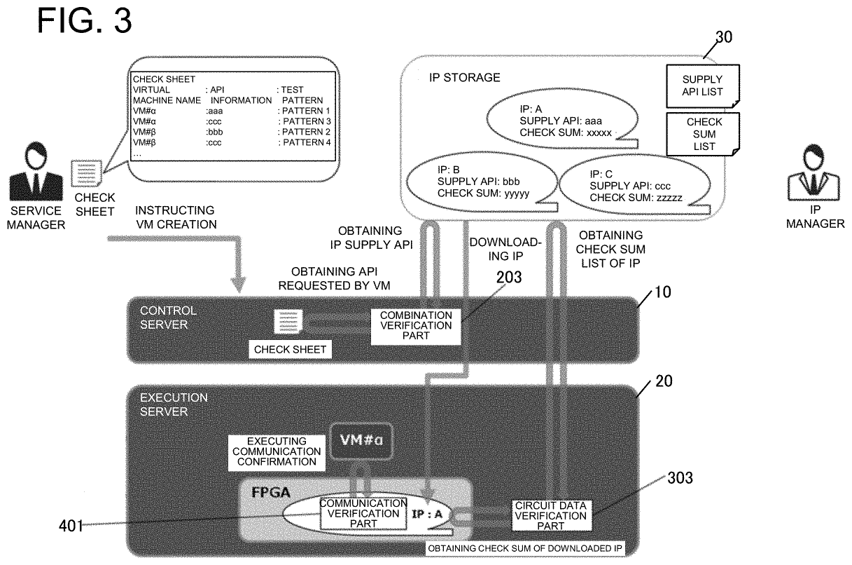

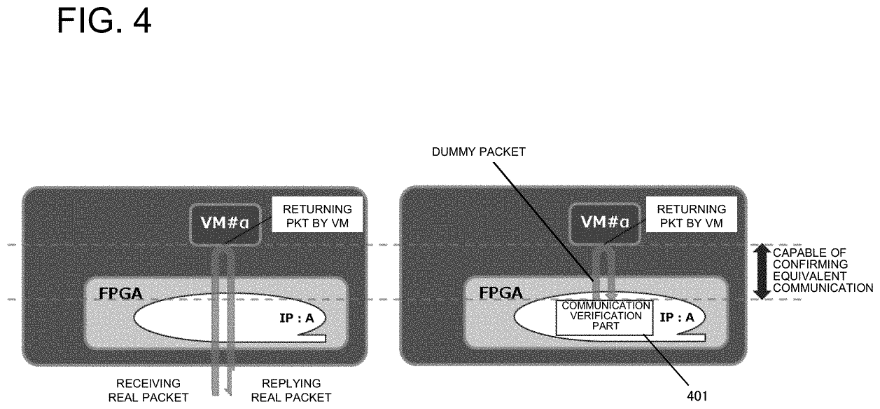

Next, an operation outline on the cloud system of the first exemplary embodiment will be explained while referring to FIG. 3 and FIG. 4. In FIG. 3 and FIG. 4, explained is operations when an IP is simultaneously downloaded (written) upon creation of a virtual machine and these processes has been correctly completed. In addition, FIG. 3 and FIG. 4 illustrates a part of processing modules on the control server 10 and the execution server 20, which are described later on.

First, the service manager instructs the control server 10 to create a virtual machine (VM). The control server 10 that received the instruction instructs the execution server 20 to create the virtual machine. In an example illustrated in FIG. 3, a virtual machine VM #α is created on the execution server 20.

FPGA is assigned to the virtual machine VM #α as a hardware resource in addition to CPU, memory, etc. FPGA comprises a CRAM (Configuration Random Access Memory) and a circuit realized by the FPGA assigned to the virtual machine VM #α is converted to IP core and written to the CRAM. For example, the virtual machine VM #α uses FPGA as a HW accelerator and leaves a part of processes to the FPGA.

An interface (data transmission/reception) between the virtual machine VM #α and PGA (IP core) is defined by an API. In the example illustrated in FIG. 3, data (packet) is transmitted/received using a type of API “aaa” that corresponds to IP=A. Herein, the type of API has been shared by the service manager and the IP manager.

The service manager instructs the control server 10 to create a virtual machine including said assignment of resources and like. In addition, the service manager inputs said check sheet to the control server 10. As described above, the check sheet associates API information and the test pattern for each virtual machine. That is, the check sheet is integrated information of a virtual machine name, API information requested by each virtual machine and a test pattern required for confirmation of operations for a service.

As illustrated in FIG. 3, for example, the virtual machine VM #α uses API “aaa” and the test pattern for verification of the operation of the API is “pattern 1”.

The control server 10 comprises a combination verification part 203. The combination verification part 203 makes reference to the check sheet and comprehends API requested by the virtual machine. In the example illustrated in FIG. 3, the combination verification part 203 comprehends that the virtual machine VM #α requests an IP having API “aaa” and “ccc”.

In such manner, the combination verification part 203 makes reference to the check sheet input by the service manager to comprehend API information corresponding to the virtual machine described on the check sheet.

The combination verification part 203 obtains a supply API list from the IP storage 30. In a case where the API information listed on the check sheet is included in the obtained supply API list, the combination verification part 203 determines that the combination of the virtual machine and the API (IP) is correct (pertinent). In a case where the API information listed on the check sheet is not included in the obtained supply API list, the combination verification part 203 determines that the combination of the virtual machine and API (IP) is incorrect (impertinent).

In a case where the combination is pertinent, the combination verification part 203 selects IP suitable for the virtual machine listed on the check sheet. For example, in the example illustrated in FIG. 3, since an API identifier (API information) used by the virtual machine VM #α is “aaa”, IP=“A” listed on the supply API list is selected. The selected IP is downloaded (written) to FPGA on the execution server 20.

The execution server 20 comprises a circuit data verification part 303. The circuit data verification part 303 accesses to FPGA on which IP has been downloaded to obtain a check sum of the downloaded IP. For example, in a case where the check sum has been written on the CRAM of FPGA, the circuit data verification part 303 accesses to the CRAM so as to obtain the check sum. Alternatively, in a case where the check sum may be calculated during the process for downloading IP, the circuit data verification part 303 obtains the calculated value as the check sum.

Further, the circuit data verification part 303 obtains a check sum list from the IP storage 30. The circuit data verification part 303 confirms whether or not a check sum corresponding to IP downloaded to FPGA is present in the obtained check sum list so as to verify correctness of the downloaded IP. That is, the circuit data verification part 303 verifies whether or not the IP has been normally downloaded from the IP storage 30.

Concretely, in a case where the check sum corresponding to the downloaded IP is present on the list, the circuit data verification part 303 determines that the IP has been downloaded normally. However, in a case where the check sum corresponding to the downloaded IP is absent on the list, the circuit data verification part 303 determines that the IP has not been downloaded normally.

In the example illustrated in FIG. 3, since the virtual machine VM #α uses IP “A”, it is determined whether or not the check sum “xxxxx” corresponding to the IP is present on the check sum list obtained from the P storage 30.

FIG. 4 is an explanatory view of operations for communication check by the execution server 20. The left side of FIG. 4 shows a traffic flow when a service is being operated. The right side of FIG. 4 shows a connection confirmation by a communication verification part 401.

The communication verification part 401 is a module incorporated in an IP to be downloaded to FPGA, and a means configured to determine whether or not data communication between a virtual machine and FPGA is normally operated.

The communication verification part 401 executes the test pattern described on the check sheet provided from the service manager by the IP manager. As illustrated in FIG. 4, the communication verification part 401 transmits a dummy packet (dummy data) corresponding to a real (actual) packet (real data) that is transmitted/received upon providing a service (FIG. 4, left side). Concretely, the communication verification part 401 transmits the dummy packet so as to demonstrate the test pattern described on the check sheet.

The communication verification part 401 transmits a dummy packet described in the check sheet to a virtual machine so as to verify whether or not a response described in the check sheet (response to the dummy packet) may be obtained. The communication verification part 401 obtains the test pattern required for confirming service operation described in the check sheet and executes communication confirmation between the virtual machine and FPGA.

In the examples illustrated in FIG. 3 and FIG. 4, the communication verification part 401 executes communication check (confirmation of a dummy packet and a response packet) regarding the test pattern 1 corresponding to IP=A used by the virtual machine VM #α.

Next, a processing configuration (processing modules) of each apparatus will be explained.

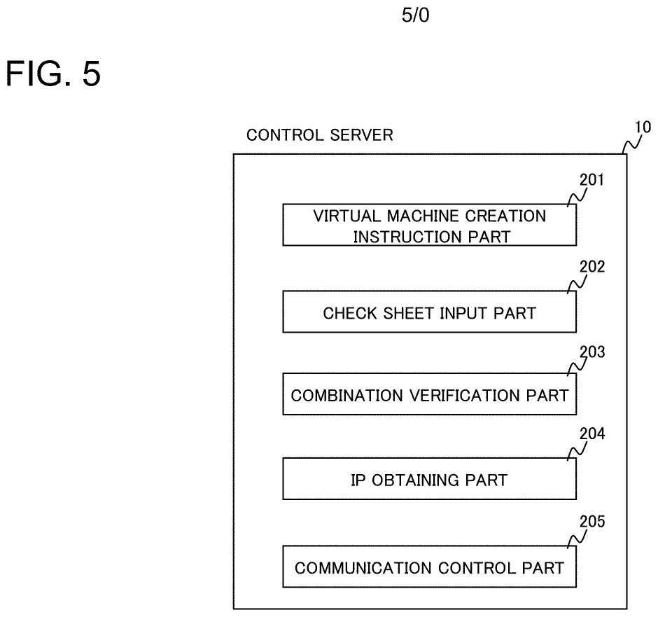

FIG. 5 is a diagram showing an example of a processing configuration (processing modules) of the control server 10 of the first exemplary embodiment. As illustrated in FIG. 5, the control server 10 is configured to comprise a virtual machine creation instruction part 201, a check sheet input part 202, a combination verification part 203, an IP obtaining part 204 and a communication control part 205.

The virtual machine creation instruction part 201 is a means configured to instruct the execution server 20 to create a virtual machine as a response to an instruction from the service manager.

The check sheet input part 202 is a means configured to input a check sheet created by the service manager. The obtained check sheet is referenced by each processing module on the control server 10 (mainly, the combination verification part 203). In addition, the check sheet input part 202 transmits the obtained check sheet to the execution server 20 via the communication control part 205.

Functions of the combination verification part 203 are as described above. The combination verification part 203 obtains API list information from the IP storage 30 and verifies the verification of the combination of the virtual machine and the IP downloaded to FPGA based on whether or not the API described in the check sheet is included in the API list information.

In a case where it is determined that the combination of the virtual machine and IP is pertinent (correct), the combination verification part 203 notifies the IP obtaining part 204 of it, and instruct it to obtain the IP from the IP storage 30.

The IP obtaining part 204 obtains (downloads) the IP whose correctness has been confirmed from the IP storage 30 and transmits the IP to the execution server 20. At that time, the IP obtaining part 204 instructs the execution server 20 to write the transmitted IP to FPGA.

As described above, the control server 10 obtains the IP which is determined to have a pertinent combination of the virtual machine and IP downloaded to FPGA from the IP storage 30, and transmits the obtained IP to the execution server 20. The execution server 20 downloads the transmitted IP to FPGA.

The communication control part 205 is a configured to control communication with the other apparatuses (for example, the execution server 20).

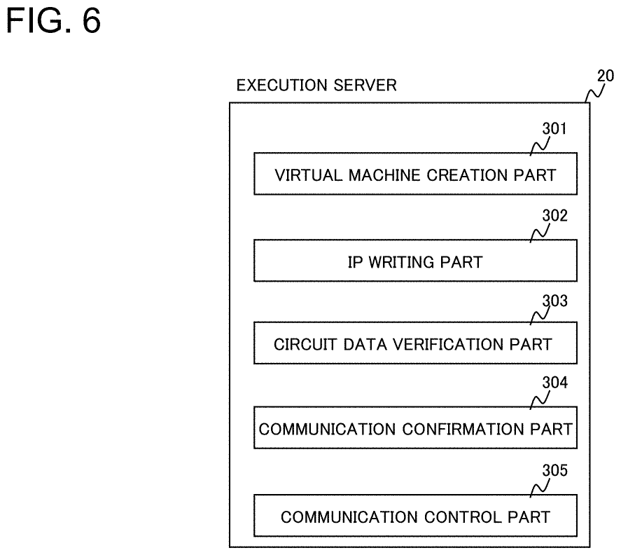

FIG. 6 is a diagram showing an example of a processing configuration (processing modules) of the execution server 20 of the first exemplary embodiment. As illustrated in FIG. 6, the execution server 20 is configured to comprise a virtual machine creation part 301, an IP writing part 302, a circuit data verification part 303, a communication confirmation part 304 and a communication control part 305.

The virtual machine creation part 301 is a means configured to create a virtual machine of a type instructed by the service manager via the control server 10.

The IP writing part 302 is a means configured to write (download) IP obtained from the control server 10 to FPGA.

Functions of the circuit data verification part 303 is as described above. The circuit data verification part 303 obtains the check sum list from the IP storage 30. The circuit data verification part 303 verifies identity between the IP downloaded to FPGA and an IP stored in the IP storage 30 based on whether or not the check sum of the IP downloaded to FPGA is included in the check sum list.

The communication confirmation part 304 is a means configured to make the communication verification part 401 to verify whether normal communication is realized between the virtual machine installed in FPGA and the IP downloaded to FPGA. Herein, as described above, the communication verification part 401 is a module or not verify whether normal data communication is realized with the virtual machine.

The communication confirmation part 304, for example, starts the communication verification part 401 installed in FPGA and supplies the communication verification part 401 with the test pattern described in the check sheet. After that, the communication confirmation part 304 instructs the communication verification part 401 to execute a communication test between the virtual machine and IP. That is, the communication confirmation part 304 supplies the communication verification part 401 with the test pattern to make the communication verification part 401 to verify whether normal communication is realized between the virtual machine and the IP downloaded in FPGA.

The communication control part 305 is a means configured to control communication with the other apparatuses (for example, the control server 10). For example, when obtaining the check sheet from the control server 10, the communication control part 305 stores the check sheet in a memory and like so that inner modules (mainly, the circuit data verification part 303 and the communication confirmation part 304) may make reference to it.

Next, a hardware configuration of each apparatus of the first exemplary embodiment will be explained.

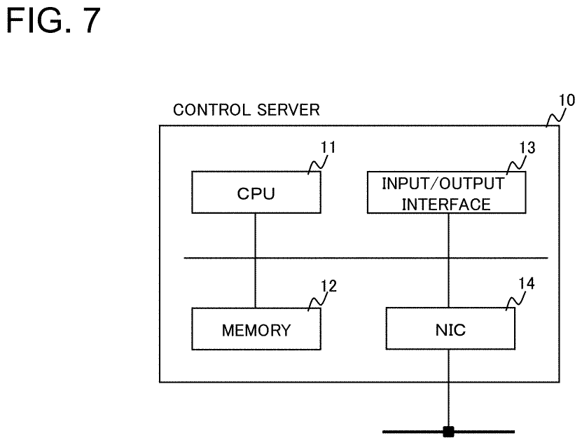

FIG. 7 is a diagram showing an example of a hardware configuration of the control server 10 of the first exemplary embodiment. The control server 10 is realized by, so called, an information processing apparatus (computer) and comprises a configuration exemplified in FIG. 7. For example, the control server 10 comprises CPU″, a memory 12, an input/output interface 13, NIC (Network Interface Card) 14 as a communication means, and like, which are mutually connected with an inner bus. Herein, the configuration illustrated in FIG. 7 is not for limitation of the hardware configuration of the control server 10. The control server 10 may comprise a hardware not shown, too.

The memory 12 comprises RAM (Random Access Memory), ROM (Read Only Memory), HDD (Hard Disk Drive) and like.

The input/output interface 13 is a means to be an interface of an input/output apparatus not shown. The input/output apparatus comprises, for example, a display apparatus, an operation device and like. The display apparatus comprises, for example, a liquid crystal display and like. The operation device comprises, for example, a keyboard, a mouse and like.

Each processing module of the above control server 10 is realized in a manner that, for example, CPU 11 executes a program stored in the memory 12. In addition, the program may be downloaded via a network or updated using a storage medium storing the program. Further, the processing module may be realized by a semiconductor chip. That is, it is enough that there is a means configured to execute functions executed by the processing modules with any hardware, and/or, software.

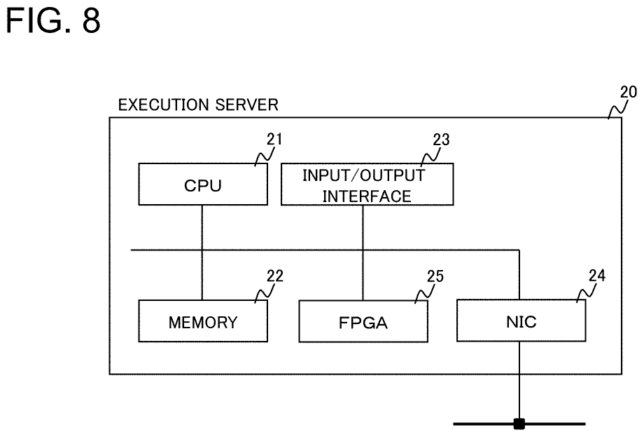

FIG. 8 is a diagram showing an example of a hardware configuration of the execution server 20 of the first exemplary embodiment. As illustrated in FIG. 8, the execution server 20 comprises FPGA 25. FPGA 25 is a semiconductor integrated circuit configured to operate IP (a circuit configured as IP core) downloaded from the IP storage 30. Herein, explanation for the other elements included in the execution server 20 is omitted, since it overlaps with the explanation on the control server 10.

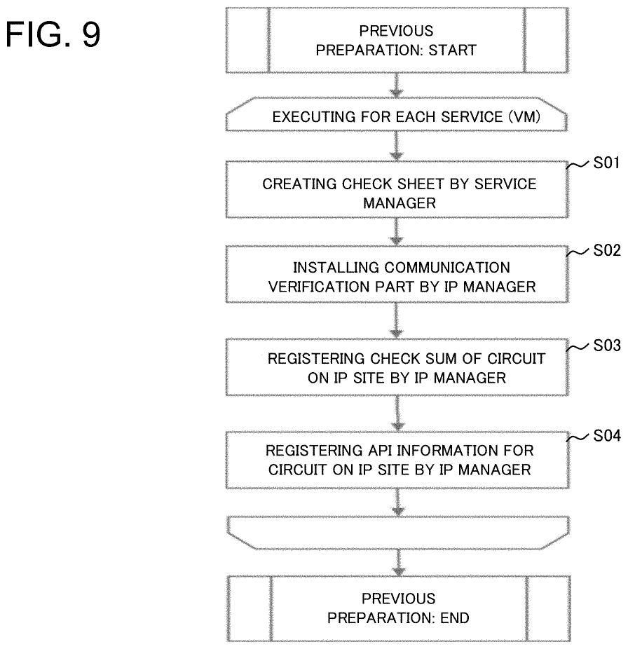

Next, operations on the cloud system of the first exemplary embodiment will be explained. First, previous preparation before system operation will be explained while referring to FIG. 9.

In step S01, the service manager creates a check sheet in which each of virtual machine name (identifier), API information used by the virtual machine (API information) and test pattern(s) required for confirmation of service operation (communication check between the virtual machine and IP) are associated therebetween.

In step S02, the IP manager installs a circuit (communication verification part) capable of operating the test pattern to IP. The IP manager releases (registers) developed IP to IP storage 30.

At that time, the IP manager registers the check sum of the released circuit (developed IP) on the IP storage 30 (step S03). In addition, the IP manager registers API information provided by the circuit (IP) on the IP storage 30 when the develop IP is released to the IP storage 30 (step S04).

The processes of the steps S01 to S04 are executed for each service (virtual machine).

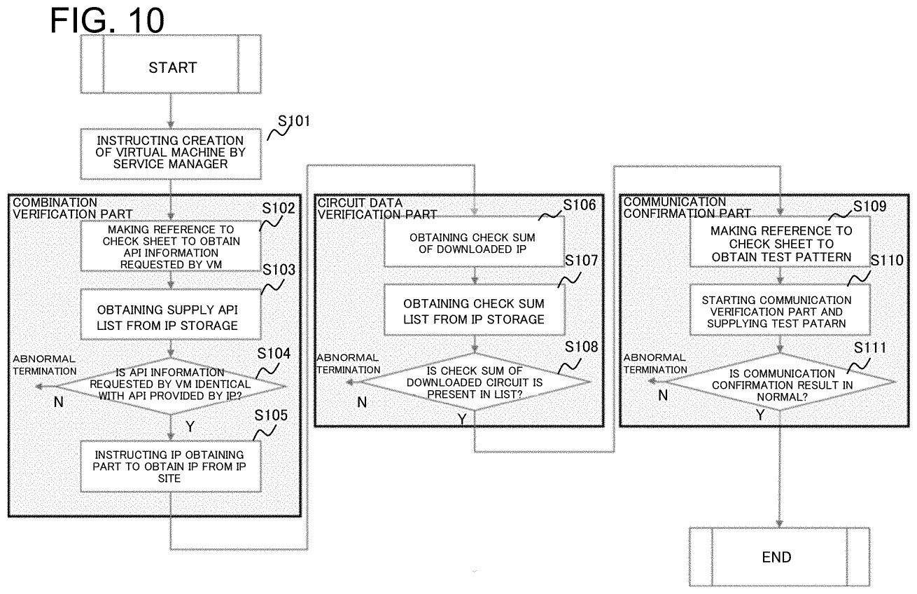

Next, operations by the control server 10 and the execution server 20 included in a first cloud site are explained while referring to FIG. 10.

In step S101, the virtual machine creation instruction part 201 obtains a virtual machine creation instruction from the service manager. The virtual machine creation instruction part 201 instructs the execution server 20 to create the virtual machine as a response to the instruction.

In step S102, the combination verification part 203 makes reference to the check sheet so as to obtain (comprehend) API information requested by the virtual machine.

In step S103, the combination verification part 203 obtains the supply API list from the IP storage 30.

In step S104, the combination verification part 203 confirms whether API information obtained in the step S102 is present or not in the supply API list obtained in the step S103. That is, the combination verification part 203 confirms whether IP pertinent to the virtual machine created on the execution server 20 is present or not in the IP storage 30.

In a case where API information described in the check sheet is included in the supply API list (step S104, branching to Yes), downstream processes as step S105 and the following are executed. In a case where API information described in the check sheet is not included in the supply API list (step S104, branching to No), the downstream processes are terminated as an irregular (i.e. abnormal) case.

In step S105, the combination verification part 203 instructs the IP obtaining part 204 to obtain the IP whose correctness has been verified in the step S104 from the IP storage 30. As a response to the instruction, the IP is downloaded from the IP storage 30 to FPGA 25.

In step S106, the circuit data verification part 303 obtains the check sum of the downloaded IP from FPGA 25.

In step S107, the circuit data verification part 303 obtains the check sum list from the IP storage 30.

In step S108, the circuit data verification part 303 confirms whether or not the check sum obtained in the step S106 is present in the check sum list obtained in the step S107. In a case where the check sum is present (step S108, branching to Yes), downstream processes as step S109 and the following are executed. In a case where the check sum is absent (step S108, branching to No), the downstream processes are terminated as an abnormal case.

In step S109, the communication confirmation part 304 makes reference to the check sheet so as to obtain the test pattern required for confirmation of service operation.

In step S110, the communication confirmation part 304 starts the communication verification part 401 installed in FPGA 25 and supplies it with the test pattern obtained in a preceding step.

The communication verification part 401 that has obtained the test pattern issues a dummy traffic along the test pattern to the virtual machine and executes the communication test.

The communication verification part 401 notifies the communication confirmation part 304 of whether or not communication (data transmission/reception) between the virtual machine and IP results in success.

In step S111, the communication confirmation part 304 confirms the result obtained from the communication verification part 401. In a case where the communication has resulted in success (step S111, branching to Yes), the processes are terminated as normal. In a case where the communication has resulted in failure (step S111, branching to No), the processes are terminated as abnormal.

As described above, in the cloud system of the first exemplary embodiment, various verifications are performed using one check sheet created by the service manager. As a result, all steps required for set up and operation of the system are automatically carried out while keeping prime relationship between the stakeholders (while keeping independence of each operator. As a result, the following problems are solved.

As described above, since the service manager is different from the IP manager and the virtual machine and IP have different life cycles, it would occur that they are respectively developed and released at different timings. That is, there is a case where the combination of the virtual machine and IP is not pertinent, such as a case where API expected by the virtual machine is not installed in IP, and like. In the first exemplary embodiment, verification of the combination of the virtual machine and IP is verified using the check sheet, thus the above problems can be solved.

In addition, there are a lot of cases where the IP storage 30 on which IP developed by the IP manager is registered and a server that uses IP (the execution server 20 as a download destination) are separated at a physically/logically long distance. Therefore, when the possibility of transfer failure of IP and like is considered, verification is required for verifying whether or not an IP registered on the IP storage is consistent with the downloaded IP. That is, it is required to confirm correctness of IP used by the virtual machine. With respect to this point, in the first exemplary embodiment, the IP manager registers a check sum value on the IP storage 30 upon releasing IP, and the correctness is verified when the control server (a controller or an infrastructure manager) downloads the IP to FPGA. That is, the check sum value of the downloaded circuit (IP) and the check sum list information for IP obtained from the IP storage 30 are compared for confirming consistency (identity) between the downloaded circuit and the released circuit so as to ensure the correctness of the circuit.

Further, there are a lot of cases where one system involves different stakeholders (the service manager, the IP manager, the infrastructure manager). Therefore, even if a combination of an IP pertinent to the service is selected, it is difficult to confirm whether normal connection is realized between the virtual machine and FPGA until traffic is actually flown from outside. With respect to this point, in the first exemplary embodiment, a dummy traffic is generated between IP, virtual machine, and IP using a communication check mechanism the (communication verification part 401) previously installed on IP so as to automatically execute a communication test between the virtual machine and the IP under a closed situation in the server. Thereby, it is confirmed that the virtual machine and IP can operate in a cooperation to perform a normal operation.

As described above, under an environment (infrastructure environment) where FPGA circuit (IP) pertinent to a service operated on the virtual machine is automatically selected so as to establish an environment using the virtual machine and the selected IP, it is automatically confirmed that the virtual machine and the IP are normally cooperated. Thereby, even in a case where the service manager, the IP manager and the infrastructure manager are different from one another, there is provided a mechanism capable of establishing the environment where the service/IP may be cooperated. That is, while keeping a situation where each of the service manager, the IP manager and the infrastructure manager, respectively, make operations independently, an adjustment is performed based on information (the check sheet) created by the service manager. As a result, selection of combination of the virtual machine and IP, correctness confirmation for IP, and communication confirmation between the virtual machine and IP may be automatically performed.

The system of the first exemplary embodiment provides at least the following 2 effects. First, combination of virtual machine/IP and construction of infrastructure environment may be automatically adjusted using the check sheet created by the service manager while keeping prime relationship between stakeholders. Second, since communication confirmation between the virtual machine and IP is automatically carried out under a closed situation in the server, it is unnecessary to carry out the communication confirmation from outside, thus it is prospected that burden for environment construction may be reduced.

### Variational Examples

The construction, operation and like of the cloud system explained in the exemplary embodiment above is an exemplification, thus it is not intended to limit the construction and like of the system. For example, functions of the control server 10 may be incorporated in the execution server 20.

The control server 10 is an apparatus that manages a plurality of execution servers 20, thus may be an apparatus that executes orchestration of hardware of each execution server 20. That is, the control server 10 may be a network function virtualization management orchestration apparatus comprising NFV-MANO (NFV Management & Orchestration) and like.

Explained in the above exemplary embodiment is a case where the IP manager installs the communication verification part 401 to IP, which executes the test pattern(s) provided from the communication confirmation part 304. However, the IP manager may install a communication verification part 401 to IP, which makes reference to a test pattern (a test pattern required for confirmation of operation of service) described in the check sheet provided from the service manager so as to execute the test pattern. That is, communication verification parts 401 respectively pertinent to each test pattern may be installed to IP, but not a communication verification part 401 generally usable for each test pattern.

In addition, although a plurality of steps (processes) are sequentially described in the plurality of flowchart used in the above explanation, the execution sequence executed in the exemplary embodiment is not limited to such described sequence. In an exemplary embodiment, the sequence of steps illustrated in figures may be changed within a range not providing any hindrance or trouble in the contents, for example, to execute each process in parallel, and like.

According to the above explanation, industrial utility of the present invention is apparent. The present invention may be preferably applied to all systems where system construction is carried out on a virtualized substrate and cooperation with FPGA is executed.

A part or the entire of the above exemplary embodiments may be described as the following modes, but not limited thereto.

### (Mode 1)

The system according to the first aspect.

### (Mode 2)

The system preferably according to Mode 1, wherein

the IP storage stores API list information provided by each of stored IP,
the control server obtains the API list information from the IP storage and verifies the pertinency of a combination of the virtual machine and an IP downloaded to the FPGA based on whether or not an API included in the check sheet is included in the API list information.

### (Mode 3)

The system preferably according to Mode 2, wherein

the control server obtains, from the IP storage, the IP which has been determined that the combination of the virtual machine and the IP downloaded to the FPGA is pertinent, and transmits the obtained IP to the execution server, and
the execution server downloads the transmitted IP to the FPGA.

### (Mode 4)

The system preferably according to Mode 3, wherein

the execution server verifies the identity of the IP downloaded to the FPGA with an IP that corresponds to the IP downloaded to the FPGA and is stored in the IP storage.

### (Mode 5)

The system preferably according to Mode 4, wherein

the IP storage stores check sum list information for the IP provided by each of the stored IP, and
the execution server obtains the check sum list information from the IP storage and verifies identity of the IP downloaded to the FPGA with the IP stored in the IP storage based on whether or not a check sum for the IP downloaded to the FPGA is included in the check sum list information.

### (Mode 6)

The system preferably according to Mode 5, wherein

the IP downloaded to the FPGA is equipped with a communication verification part that verifies whether or not it may normally execute transmission and reception of data with the virtual machine, and
the execution server makes the communication verification part to execute verification whether or not the virtual machine may normally execute transmission and reception of data with the IP downloaded to the FPGA.

### (Mode 7)

The system preferably according to Mode 6, wherein

the check sheet includes a test pattern for the API used by the virtual machine, and
the execution server supplies the communication verification part with the test pattern so that the communication verification part executes verification whether or not the virtual machine may normally execute transmission and reception of data with the IP downloaded to the FPGA.

### (Mode 8)

The system preferably according to any one of Modes 1 to 7, wherein

the control server instructs the execution server to create the virtual machine.

### (Mode 9)

The system preferably according to any one of Modes 5 to 7, wherein

the IP storage creates the API list information and the check sum list information based on information obtained from a manager carrying out development and management for IP.

### (Mode 10)

The server according to the above second aspect.

### (Mode 11)

The control server according to Mode 10, wherein

the IP storage stores API list information provided by each of the stored IP, the control server obtains the API list information from the IP storage and verifies the pertinency of a combination of the virtual machine and an IP downloaded to the FPGA based on whether or not an API included in the check sheet is included in the API list information.

### (Mode 12)

The control server according to Mode 11, wherein

the control server obtains, from the IP storage, the IP which has been determined that the combination of the virtual machine and the IP downloaded to the FPGA is pertinent, and transmits the obtained IP to the execution server so that the execution server downloads the transmitted IP to the FPGA.

### (Mode 13)

The control server according to Mode 12, wherein

the control server makes the execution server to verify the identity of the IP downloaded to the FPGA with an IP that corresponds to the IP downloaded to the FPGA and is stored in the IP storage.

### (Mode 14)

The control server according to Mode 13, wherein

the IP storage stores check sum list information for the IP provided by each of the stored IP, and
the control server makes the execution server to obtain the check sum list information from the IP storage and to verify identity of the IP downloaded to the FPGA with the IP stored in the IP storage based on whether or not a check sum for IP downloaded to the FPGA is included in the check sum list information.

### (Mode 15)

The control server according to Mode 14, wherein

the IP downloaded to the FPGA is equipped with a communication verification part that verifies whether or not it may normally execute transmission and reception of data with the virtual machine, and
the control server makes the communication verification part to execute verification whether or not the virtual machine may normally execute transmission and reception of data with the IP downloaded to the FPGA.

### (Mode 16)

The control server according to Mode 15, wherein

the check sheet includes a test pattern for the API used by the virtual machine, and
the control server makes the execution server to supply the communication verification part with the test pattern so that the communication verification part executes verification whether or not the virtual machine may normally execute transmission and reception of data with the IP downloaded to the FPGA.

### (Mode 17)

The control server according to any one of Modes 10 to 16, wherein the control server instructs the execution server to create the virtual machine.

### (Mode 18)

The control server according to any one of Modes 14 to 16, wherein

the control server makes the IP storage to create the API list information and the check sum list information based on information obtained from a manager carrying out development and management for IP.

### (Mode 19)

The verification method according to the above third aspect.

### (Mode 20)

The verification method preferably according to Mode 19, wherein the IP storage stores API list information provided by each of the stored IP, and

the method includes a step of obtaining the API list information from the IP storage and verifying the pertinency of a combination of the virtual machine and an IP downloaded to the FPGA based on whether or not an API included in the check sheet is included in the API list information.

### (Mode 21)

The system preferably according to Mode 20, wherein the method includes a step of obtaining, from the IP storage, the IP which has been determined that the combination of the virtual machine and the IP downloaded to the FPGA is pertinent, and transmitting the obtained IP to the execution server so that the execution server downloads the transmitted IP to the FPGA.

### (Mode 22)

The verification method according to Mode 21, wherein

the method includes a step of making the execution server to verify the identity of the IP downloaded to the FPGA with an IP that corresponds to the IP downloaded to the FPGA and is stored in the IP storage.

### (Mode 23)

The verification method according to Mode 22, wherein

the IP storage stores check sum list information for the IP provided by each of the stored IP, and
the method includes a step of making the execution server to obtain the check sum list information from the IP storage and to verify identity of the IP downloaded to the FPGA with the IP stored in the IP storage based on whether or not a check sum for IP downloaded to the FPGA is included in the check sum list information.

### (Mode 24)

The verification method according to Mode 23, wherein

the IP downloaded to the FPGA is equipped with a communication verification part that verifies whether or not it may normally execute transmission and reception of data with the virtual machine, and
the method includes a step of making the communication verification part to execute verification whether or not the virtual machine may normally execute transmission and reception of data with the IP downloaded to the FPGA.

### (Mode 25)

The verification method according to Mode 24, wherein the check sheet includes a test pattern for the API used by the virtual machine, and

the method includes a step of making the execution server to supply the communication verification part with the test pattern so that the communication verification part executes verification whether or not the virtual machine may normally execute transmission and reception of data with the IP downloaded to the FPGA.

### (Mode 26)

The verification method according to any one of Modes 19 to 25, wherein

the method includes a step of instructing the execution server to create the virtual machine.

### (Mode 27)

The verification method according to any one of Modes 23 to 25, wherein

the method includes a step of making the IP storage to create the API list information and the check sum list information based on information obtained from a manager carrying out development and management for IP.

### (Mode 28)

The program according to the above fourth aspect.

### (Mode 29)

The program according to Mode 28, wherein

the IP storage stores API list information provided by each of the stored IP, the program causes the computer to execute a process of obtaining the API list information from the IP storage and verifying the pertinency of a combination of the virtual machine and an IP downloaded to the FPGA based on whether or not an API included in the check sheet is included in the API list information.

### (Mode 30)

The program according to Mode 29, wherein

the program causes the computer to execute a process of obtaining, from the IP storage, the IP which has been determined that the combination of the virtual machine and the IP downloaded to the FPGA is pertinent, and transmitting the obtained IP to the execution server so that the execution server downloads the transmitted IP to the FPGA.

### (Mode 31)

The program according to Mode 30, wherein

the program causes the computer to instruct the execution server to execute a process of verifying the identity of the IP downloaded to the FPGA with an IP that corresponds to the IP downloaded to the FPGA and is stored in the IP storage.

### (Mode 32)

The program according to Mode 31, wherein

the IP storage stores check sum list information for the IP provided by each of the stored IP, and
the program causes the computer to instruct the execution server to execute a process of instructing the execution server to obtain the check sum list information from the IP storage and verify identity of the IP downloaded to the FPGA with the IP stored in the IP storage based on whether or not a check sum for the IP downloaded to the FPGA is included in the check sum list information.

### (Mode 33)

The program according to Mode 32, wherein

the IP downloaded to the FPGA is equipped with a communication verification part that verifies whether or not it may normally execute transmission and reception of data with the virtual machine, and
the program causes the computer to instruct the communication verification part to execute a process of verification whether the virtual machine may normally execute transmission and reception of data with the IP downloaded to the FPGA.

### (Mode 34)

The program according to Mode 33, wherein

the check sheet includes a test pattern for the API used by the virtual machine, and
the program causes the computer to instruct the execution server to execute a process of supplying the communication verification part with the test pattern so that the communication verification part executes verification whether or not the virtual machine may normally execute transmission and reception of data with the IP downloaded to the FPGA.

### (Mode 35)

The program according to any one of Modes 28 to 34, wherein

the program causes the computer to instruct the execution server to execute a process of creating the virtual machine.

### (Mode 36)

The program according to any one of Modes 32 to 34, wherein

the program causes the computer to instruct the IP storage to execute a process of creating the API list information and the check sum list information based on information obtained from a manager carrying out development and management for IP.

Herein, configurations of Modes 10, 19, 28 may be developed to the configurations of Mode 2 to Mode 9, similarly to the configuration of Mode 1. For example, Mode 10 may be developed like as Modes 11 to 18, but not limiting developed configuration thereto.

Disclosure of the above Non-Patent Literature is incorporated herein by reference thereto. Modifications and adjustments of the exemplary embodiments and examples are possible within the ambit of the disclosure (including the claims) of the present invention and based on basic technical concept therein. Various combinations and selections (including non-selections) of various disclosed elements (including the elements in the claims, exemplary embodiments, examples, drawings, etc.) are possible within the ambit of the disclosure of the present invention. Namely, the present invention of course includes various variations and modifications that could be made by those skilled in the art according to the overall disclosure including the claims and the technical concept. Particularly, with respect to the numerical value ranges disclosed in the present application should be interpreted to concretely disclose an arbitrary numerical value or a small range within the range, even in a case where explicit disclosure is absent.

### REFERENCE SIGNS LIST

10, 101 control server
11, 21 CPU (Central Processing Unit)
12, 22 memory
13, 23 input/output interface
14, 24 NIC (Network Interface Card)
20, 100 execution server
25 FPGA (Field Programmable Gate Array)
30, 102 IP storage
40-1 to 40-3 terminal
201 virtual machine creation instruction part
202 check sheet input part
203 combination verification part
204 IP obtaining part
205, 305 communication control part
301 virtual machine creation part
302 IP writing part
303 circuit data verification part
304 communication confirmation part
401 communication verification part

1. A system, comprising:
an execution server that is equipped with an FPGA (Field Programmable Gate Array) and creates a virtual machine which uses the FPGA as one of hardware resources,
a control server that controls the execution server, and an IP storage that stores an IP (Intellectual Property) to be downloaded to the FPGA,
wherein the control server makes reference to a check sheet including information for associating at least the virtual machine with an API (Application Programming Interface) used by the virtual machine and verifies the pertinency of a combination of the virtual machine and the IP which has been stored in the IP storage and to be downloaded to the FPGA.

2. The system according to claim 1, wherein
the IP storage stores API list information provided by each of the stored IP,
the control server obtains the API list information from the IP storage and verifies the pertinency of a combination of the virtual machine and an IP downloaded to the FPGA based on whether or not an API included in the check sheet is included in the API list information.

3. The system according to claim 2, wherein
the control server obtains, from the IP storage, the IP which has been determined that the combination of the virtual machine and the IP downloaded to the FPGA is pertinent, and transmits the obtained IP to the execution server, and
the execution server downloads the transmitted IP to the FPGA.

4. The system according to claim 3, wherein
the execution server verifies the identity of the IP downloaded to the FPGA with an IP that corresponds to the IP downloaded to the FPGA and is stored in the IP storage.

5. The system according to claim 4, wherein
the IP storage stores check sum list information for the IP provided by each of the stored IP, and
the execution server obtains the check sum list information from the IP storage and verifies identity of the IP downloaded to the FPGA with the IP stored in the IP storage based on whether or not a check sum for the IP downloaded to the FPGA is included in the check sum list information.

6. The system according to claim 5, wherein
the IP downloaded to the FPGA is equipped with a communication verification part that verifies whether or not it may normally execute transmission and reception of data with the virtual machine, and
the execution server makes the communication verification part to execute verification whether or not the virtual machine may normally execute transmission and reception of data with the IP downloaded to the FPGA.

7. The system according to claim 6, wherein
the check sheet includes a test pattern for the API used by the virtual machine, and
the execution server supplies the communication verification part with the test pattern so that the communication verification part executes verification whether or not the virtual machine may normally execute transmission and reception of data with the IP downloaded to the FPGA.

8. The system according to claim 1, wherein
the control server instructs the execution server to create the virtual machine.

9. The system according to claim 5, wherein
the IP storage creates the API list information and the check sum list information based on information obtained from a manager carrying out development and management for IP.

10. A control server, connected to
an execution server that is equipped with an FPGA (Field Programmable Gate Array) and creates a virtual machine which uses the FPGA as one of hardware resources, and
an IP storage that stores an IP (Intellectual Property) to be downloaded to the FPGA, and
making reference to a check sheet including information for associating at least the virtual machine with an API (Application Programming Interface) used by the virtual machine and verifies the pertinency of a combination of the virtual machine and the IP which has been stored in the IP storage and to be downloaded to the FPGA.

11. A verification method in a system comprising:
an execution server that is equipped with an FPGA (Field Programmable Gate Array) and creates a virtual machine which uses the FPGA as one of hardware resources,
a control server that controls the execution server, and
an IP storage that stores an IP (Intellectual Property) to be downloaded to the FPGA, wherein the control server is configured to execute the following processes:
making reference to a check sheet including information for associating at least the virtual machine with an API (Application Programming Interface) used by the virtual machine, and
verifying the pertinency of a combination of the virtual machine and the IP which has been stored in the IP storage and to be downloaded to the FPGA.

12. (canceled)

13. The control server according to claim 10, wherein
the IP storage stores API list information provided by each of the stored IP,
the control server obtains the API list information from the IP storage and verifies the pertinency of a combination of the virtual machine and an IP downloaded to the FPGA based on whether or not an API included in the check sheet is included in the API list information.

14. The control server according to claim 13, wherein
the control server obtains, from the IP storage, the IP which has been determined that the combination of the virtual machine and the IP downloaded to the FPGA is pertinent, and transmits the obtained IP to the execution server, and
the execution server downloads the transmitted IP to the FPGA.

15. The control server according to claim 14, wherein
the execution server verifies the identity of the IP downloaded to the FPGA with an IP that corresponds to the IP downloaded to the FPGA and is stored in the IP storage.

16. The control server according to claim 15, wherein
the IP storage stores check sum list information for the IP provided by each of the stored IP, and
the execution server obtains the check sum list information from the IP storage and verifies identity of the IP downloaded to the FPGA with the IP stored in the IP storage based on whether or not a check sum for the IP downloaded to the FPGA is included in the check sum list information.

17. The control server according to claim 16, wherein
the IP downloaded to the FPGA is equipped with a communication verification part that verifies whether or not it may normally execute transmission and reception of data with the virtual machine, and
the execution server makes the communication verification part to execute verification whether or not the virtual machine may normally execute transmission and reception of data with the IP downloaded to the FPGA.

18. The control server according to claim 17, wherein
the check sheet includes a test pattern for the API used by the virtual machine, and
the execution server supplies the communication verification part with the test pattern so that the communication verification part executes verification whether or not the virtual machine may normally execute transmission and reception of data with the IP downloaded to the FPGA.

19. The control server according to claim 10, wherein
the control server instructs the execution server to create the virtual machine.

20. The control server according to claim 16, wherein
the IP storage creates the API list information and the check sum list information based on information obtained from a manager carrying out development and management for IP.

21. The verification method according to claim 11, wherein
the IP storage stores API list information provided by each of the stored IP,
the control server is configured to obtain the API list information from the IP storage and verifies the pertinency of a combination of the virtual machine and an IP downloaded to the FPGA based on whether or not an API included in the check sheet is included in the API list information.
